(19) United States
(12) Patent Application Publication
(10) Pub. No.: US 2019/0386341 A1
(43) Pub. Date: Dec. 19, 2019

(54) NONAQUEOUS ELECTROLYTE SECONDARY BATTERY

(71) Applicant: Panasonic Intellectual Property Management Co., Ltd., Osaka-shi, Osaka (JP)

(72) Inventors: Ryo Kazawa, Kanagawa (JP); Yuta Kuroda, Osaka (JP); Masanobu Takeuchi, Tokyo (JP)

(73) Assignee: Panasonic Intellectual Property Management Co., Ltd., Osaka-shi, Osaka (JP)

(21) Appl. No.: 16/480,847

(22) PCT Filed: Jan. 17, 2018
(86) PCT No.: PCT/JP2018/001106

§ 371 Date: Jul. 25, 2019

(30) Foreign Application Priority Data
Jan. 30, 2017 (JP) 2017-014599

(51) Int. Cl. H01M 10/0569; H01M 4/133; H01M 4/62

(52) U.S. Cl. CPC H01M 10/0569; H01M 2300/0034; H01M 4/623; H01M 4/133

(57) ABSTRACT

Provided is a nonaqueous electrolyte secondary battery comprising: a negative electrode having a negative electrode active substance layer; a positive electrode; and a nonaqueous electrolyte containing a nonaqueous solvent. The negative electrode active substance layer contains: a negative electrode active substance containing a carbon-based active substance; and layered silicate particles. The nonaqueous solvent contains a fluorine-based solvent.

### TECHNICAL FIELD

The present invention relates to a technique of a non-aqueous electrolyte secondary battery.

### BACKGROUND ART

Patent Literature 1, for example, discloses a non-aqueous electrolyte secondary battery that includes a non-aqueous electrolyte including a fluorinated solvent. Patent Literature 1 discloses that charging/discharging cyclic characteristics are improved by using a non-aqueous electrolyte including a fluorinated solvent.

Patent Literature 2, for example, discloses a non-aqueous electrolyte secondary battery that includes an electrode material, which contains an electrode active material, comprising a clay mineral in an amount of the range of 5% by weight or less based on the total weight of the electrode material for increasing the mechanical strength of the electrode material and improving the impregnation ability of an electrolyte.

### CITATION LIST

### Patent Literature

PATENT LITERATURE 1: Japanese Unexamined Patent Application Publication No. 2008-140760

PATENT LITERATURE 2: Japanese Unexamined Patent Application Publication No. 2008-71757

### SUMMARY

Using a non-aqueous electrolyte including a fluorinated solvent as disclosed in Patent Literature 1 is effective as means for improving charging/discharging cyclic characteristics of a non-aqueous electrolyte secondary battery, but, on the other hand, is problematic in that it increases the resistance of the negative electrode to thereby decrease output characteristics of the non-aqueous electrolyte secondary battery. Particularly, in an environment at a low temperature (for example, at 15° C. or less), the increase in the resistance of the negative electrode may be significant to thereby considerably decrease output characteristics of the non-aqueous electrolyte secondary battery.

Therefore, it is an advantage of the present disclosure to provide a non-aqueous electrolyte secondary battery that includes a non-aqueous electrolyte including a fluorinated solvent and can suppress the increase in the resistance of the negative electrode thereof in an environment at a low temperature.

The non-aqueous electrolyte secondary battery according to one aspect of the present disclosure includes: a negative electrode having a negative electrode active material layer; a positive electrode; and a non-aqueous electrolyte including a non-aqueous solvent, wherein the negative electrode active material layer includes: a negative electrode active material including a carbon active material; and layered silicate particles, and the non-aqueous solvent includes a fluorinated solvent.

According to one aspect of the present disclosure, the increase in the resistance of the negative electrode in an environment at a low temperature can be suppressed in a non-aqueous electrolyte secondary battery that includes a non-aqueous electrolyte including a fluorinated solvent.

### BRIEF DESCRIPTION OF DRAWING

FIG. 1 is a schematic perspective view illustrating an exemplary layered silicate particle.

### DESCRIPTION OF EMBODIMENTS

### (Suppression Effect on Increase in Resistance of Negative Electrode in Environment at Low Temperature)

As stated above, using a non-aqueous electrolyte including a fluorinated solvent is effective as means for improving charging/discharging cyclic characteristics of a non-aqueous electrolyte secondary battery. The reason of this is considered as follows: in the initial charge of a non-aqueous electrolyte secondary battery, a part of the fluorinated solvent in the non-aqueous electrolyte is decomposed on the surface of the carbon active material of the negative electrode to thereby form a film derived from the fluorinated solvent (SEI film) on the surface of the carbon active material, and in the charging/discharging process thereafter, the film suppresses the further decomposition of the non-aqueous electrolyte. However, because fluorinated solvents have a high reactivity for decomposition, a large amount of the SEI film derived from a fluorinated solvent is likely to form on the surface of a carbon active material. Furthermore, because the SEI film derived from a fluorinated solvent has a low ion permeability in an environment at a low temperature, a large amount of the SEI film that is derived from a fluorinated solvent are formed on the surface of a carbon active material, which leads to the increase in the resistance of the negative electrode in an environment at a low temperature. As a result of earnest studies, the present inventors have found that a layered silicate is effective as a substance that suppresses the production of an SEI film derived from a fluorinated solvent. Specifically, it is considered that when using a negative electrode having a negative electrode active material layer that includes a negative electrode active material including a carbon active material and a layered silicate as in the non-aqueous electrolyte secondary battery of one aspect of the present disclosure, the layered silicate in the negative electrode active material layer repels the fluorinated solvent due to electrostatic interactions, and that thus excessive approach of the fluorinated solvent to the carbon active material is suppressed to thereby suppress the decomposition of the fluorinated solvent. It is probably considered that as a result, the amount of SEI film produced that is derived from a fluorinated solvent can be reduced to thereby suppress the increase in the resistance of the negative electrode in an environment at a low temperature. It is considered that the repellence between the layered silicate and the fluorinated solvent due to electrostatic interactions is mainly the repellence due to electrostatic interactions between the negative charge of the layered silicate and the fluoro group of the fluorinated solvent.

An exemplary non-aqueous electrolyte secondary battery according to the present embodiment will be described below.

The exemplary non-aqueous electrolyte secondary battery according to the present embodiment includes a positive electrode, a negative electrode, and a non-aqueous electrolyte. A separator is preferably provided between the positive electrode and the negative electrode. Specifically, the non-aqueous electrolyte secondary battery has a structure in which an electrode assembly and the non-aqueous electrolyte are housed in an exterior body, the electrode assembly having a wound structure in which the positive electrode and the negative electrode are wound together with the separator interposed therebetween. The electrode assembly is not limited to those having a wound structure, and an electrode assembly in another form may be used, including an electrode assembly having a laminated structure in which positive electrodes and negative electrodes are laminated with separators interposed therebetween. The form of the non-aqueous electrolyte secondary battery is not particularly limited, and examples thereof include a cylindrical shape, a rectangular shape, a coin shape, a button shape, and a laminate.

The non-aqueous electrolyte, the positive electrode, the negative electrode, and the separator used in the exemplary non-aqueous electrolyte secondary battery according to the present embodiment will be described in detail below.

### [Non-Aqueous Electrolyte]

The non-aqueous electrolyte includes: a non-aqueous solvent including a fluorinated solvent; and an electrolyte salt. The non-aqueous electrolyte is not limited to a liquid electrolyte (non-aqueous electrolyte solution), and may be a solid electrolyte using a polymer gel or the like.

The fluorinated solvent included in the non-aqueous solvent is not particularly limited as long as it is a solvent compound having a hydrocarbon moiety a hydrogen atom of which has been replaced with a fluorine atom. Examples thereof include fluorinated ethers, fluorinated phosphate esters, fluorinated carboxylate esters, and fluorinated carbonates. These are compounds formed by replacing at least one hydrogen atom of a compound, such as an ether, a phosphate ester, a carboxylate ester, or a carbonate, with a fluorine atom. Among these examples, fluorinated carbonates are preferable in view of, for example, suppressing the decrease in charging/discharging cycle characteristics of the non-aqueous electrolyte secondary battery.

Examples of the fluorinated ethers include, but not limited to, CF₃OCH₃, CF₃OC₂H₅, F(CF₂)₂OCH₃, F(CF₂)₂OC₂H₅, CF₃(CF₂)CH₂O(CF₂)CF₃, and F(CF₂)₃OCH₃.

Examples of the fluorinated phosphate esters include, but not limited to, fluorinated alkyl phosphate ester compounds such as tris(trifluoromethyl) phosphate, tris(pentafluoroethyl) phosphate, tris(2,2,2-trifluoroethyl) phosphate, and tris(2,2,3,3-tetrafluoroethyl) phosphate.

Examples of the fluorinated carboxylate esters include, but not limited to, ethyl pentafluoropropionate, ethyl 3,3,3-trifluoropropionate, methyl 2,2,3,3-tetrafluoropropionate, 2,2-difluoroethyl acetate, and methyl heptafluoroisobutyrate.

As the fluorinated carbonate, any of linear fluorinated carbonates and cyclic fluorinated carbonates can be used, and a cyclic fluorinated carbonate is preferable in view of, for example, suppressing the decrease in charging/discharging cycle characteristics of the non-aqueous electrolyte secondary battery.

Examples of the linear fluorinated carbonates include, but not limited to, those formed by replacing one or more hydrogen atoms of a linear carbonate with one or more fluorine atoms, and examples of the linear carbonate include dimethyl carbonate (DMC), diethyl carbonate (DEC), and methyl ethyl carbonate (DMC).

Examples of the cyclic fluorinated carbonates include, but not limited to, fluoroethylene carbonate (FEC), 1,2-difluoroethylene carbonate, 1,2,3-trifluoropropylene carbonate, 2,3-difluoro-2,3-butylene carbonate, and 1,1,1,4,4,4-hexafluoro-2,3-butylene carbonate. Among these, fluoroethylene carbonate is preferable in view of, for example, suppressing the decrease in charging/discharging cycle characteristics of the non-aqueous electrolyte secondary battery, and reducing the amount of hydrofluoric acid generated at a high temperature.

For example, the content of the fluorinated solvent is preferably 5 vol % or more and 30 vol % or less, more preferably 10 vol % or more and 20 vol % or less, based on the total volume of the non-aqueous solvent. If the content of the fluorinated solvent is less than 5 vol %, the amount produced of the SEI film derived from the fluorinated solvent may be too small to sufficiently suppress the decrease in charging/discharging cycle characteristics. If the content of the fluorinated solvent is more than 30 vol %, the amount of the SEI film produced that is derived from the fluorinated solvent may not be sufficiently reduced even by the effect provided by adding the layered silicate.

In addition to the fluorinated solvent, the non-aqueous solvent may include a fluorine-free solvent, for example. Examples of the fluorine-free solvent include cyclic carbonates, such as ethylene carbonate, propylene carbonate, and butylene carbonate; chain carbonates, such as dimethyl carbonate, diethyl carbonate, and methyl ethyl carbonate; carboxylate esters, such as methyl acetate and ethyl acetate; cyclic ethers, such as 1,3-dioxolane and tetrahydrofuran; linear ethers, such as 1,2-dimethoxyethane and diethyl ether; nitriles, such as acetonitrile; and amides such as dimethylformamide.

The electrolyte salt included in the non-aqueous electrolyte is preferably a lithium salt. As the lithium salt, those generally used as a supporting electrolyte for conventional non-aqueous electrolyte secondary batteries can be used. Specific examples thereof include LiPF₆, LiBF₄, LiAsF₆, LiClO₄, LiCF₃SO₃, LiN(FSO₂)₂, LiN(C₁F₂₁₊₁SO₂)(CₘF₂ₘ₊₁SO₂) (where l and m are each an integer of 1 or more), LiC(CₚF₂ₚ₊₁SO₂)(C_{q}F_{2q+1}SO₂)(CᵣF₂ᵣ₊₁SO₂)(where p, q, and r are each an integer of 1 or more), Li[B(C₂O₄)F₂] (lithium bis(oxalate)borate (LiBOB)), Li[B(C₂O₄)F₂], and Li[P(C₂O₄)F₄], and Li[P(C₂O₄)₂F₂]. These lithium salts may be used singly or in combinations of two or more thereof.

### [Positive Electrode]

The positive electrode includes, for example, a positive electrode collector such as metal foil and a positive electrode active material layer formed on the positive electrode collector. Foil of a metal, such as aluminum, that is stable in the electric potential range of the positive electrode, a film with such a metal disposed as an outer layer, and the like can be used for the positive electrode collector. The positive electrode can be produced by, for example, applying a positive electrode mixture slurry containing the positive electrode active material, the binder, and other components to the positive electrode collector to thereby form a positive electrode active material layer on the positive electrode collector, and drying and rolling the positive electrode active material layer.

A lithium-containing transition metal oxide, for example, is used as the positive electrode active material. Examples of the lithium-containing transition metal oxide include lithium cobalt oxides, lithium manganese oxides, lithium nickel oxides, lithium nickel manganese composite oxides, and lithium nickel cobalt composite oxides. These may be used singly or in combinations of two or more. These lithium-containing transition metal oxides may be doped with Al, Ti, Zr, Nb, B, W, Mg, Mo, or the like.

Examples of the electrical conductor include carbon powders such as carbon black, acetylene black, Ketjenblack, and graphite. These may be used singly or in combinations of two or more thereof.

Examples of the binder include a fluorinated polymer and a rubber polymer. Examples of the fluorinated polymer include polytetrafluoroethylene (PTFE), poly (vinylidene fluoride) (PVdF), and modified products thereof, and examples of the rubber polymer include an ethylene/propylene/isoprene copolymer and an ethylene/propylene/butadiene copolymer. These may be used singly or in combinations of two or more thereof.

### [Negative Electrode]

The negative electrode includes, for example, a negative electrode collector such as a metal foil, and a negative electrode active material layer formed on the negative electrode collector. Foil of a metal, such as copper, that is stable in the electric potential range of the negative electrode, a film with such a metal disposed as an outer layer, and the like can be used for the negative electrode collector.

The negative electrode active material layer includes a negative electrode active material and layered silicate particles. In addition to these, the negative electrode active material layer preferably includes a polymeric thickener and a binder. The negative electrode can be produced by, for example, applying to the negative electrode collector a negative electrode mixture slurry containing the negative electrode active material, the layered silicate particles, the polymeric thickener, and the binder to thereby form a negative electrode active material layer on the negative electrode collector, and drying and rolling the negative electrode active material layer.

The negative electrode active material includes a carbon active material. Examples of the carbon material include graphite, non-graphitizable carbon, graphitizable carbon, fibrous carbon, coke, and carbon black. These may be used singly or in combinations of two or more. For example, the content of the carbon active material is preferably, but not particularly limited to, 95 mass % or more based on the total amount of the negative electrode active material.

The negative electrode active material may include a non-carbon active material that can intercalate and deintercalate lithium ions, in addition to the carbon active material. Examples of the non-carbon active material include silicon, tin, and an alloy and an oxide including silicon or tin mainly. These may be used singly or in combinations of two or more.

The layered silicate particle is composed of tetrahedral layers, which is composed of tetrahedral structures of silica that range themselves planarly, and octahedral layers, which is composed of octahedral structures that range themselves planarly and include lithium, aluminum, magnesium, or the like as a center metal, and the layered silicate particle is a substance formed of these layers laminated. Specific examples thereof include hectorite, pyrophyllite (mica), sericite, montmorillonite, beidellite, kaolin mineral (e.g., kaolinite, naclight, and deckite), halloysite, serpentine mineral (e.g., antigorite, chrysotile, amessite, kronsteadite, and chamosite), chlorite, interstratified mineral (e.g., rectorite, korensite, and tosudite), and double chain minerals (e.g., attapulgite and allophane). These may be used singly or in combinations of two or more.

Among the substances listed above, hectorite is preferable in view of the large effect of suppressing the formation of an SEI film derived from a fluorinated solvent. For example, hectorite is a substance having a layered structure composed of tetrahedral layers, which include tetrahedral structures of silica, and octahedral layers, which include octahedral structures that include Mg and Li as a center metal, the substance including cations such as Na ions and water molecules in the layered structure. Specific examples thereof include Na^{+0.7}[(Si₈Mg_{5.5}Li_{0.3})O₂₀(OH)₄]^{-0.7}.

The layered silicate particles can be obtained by, for example, heating a solution that includes a salt of metal such as sodium, magnesium, and lithium and sodium silicate mixed at prescribed concentrations to thereby obtain a precipitate, filtering off the precipitate, and washing, drying, and pulverizing the resultant precipitate. However, the method for preparing the layered silicate particles is not limited to the above, and any of conventionally known methods therefor may be applied.

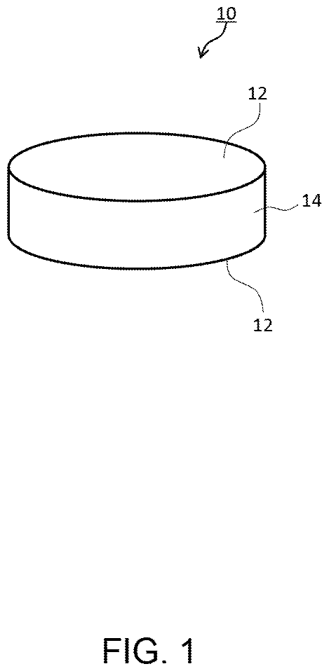

FIG. 1 is a schematic perspective view illustrating an exemplary layered silicate particle. The particulate form of the layered silicate particle is a platy particle 10, as shown in FIG. 1, due to the crystal structure of the layered silicate. The contour of the platy particle 10 is defined by a pair of plane faces 12 that faces each other and a side 14 across the gap between the pair of plane faces 12, the side 14 extending along the circumferences of the plane faces 12. The shape of the plane face 12 of the platy particle 10 shown in FIG. 1 is a disk but is not limited thereto, and it may be any of polygonal, oval, or irregular.

The platy particle herein means a particle in which the area of the plane face is larger than that of the side of the particle. Here, the area of the plane face means the area of one of the pair of plane faces that faces each other.

For the layered silicate particles used in the present embodiment, the ratio SB/SA of the area of the plane face of the platy particle, SB, to the area of the side of the platy particle, SA, is preferably 12.5 or more, and more preferably 12.5 or more and 20 or less. When using platy particles having a ratio SB/SA of 12.5 or more, the formation of an SEI film derived from a fluorinated solvent can be suppressed more effectively to thereby highly suppress the increase in the resistance of the negative electrode in an environment at a low temperature. A reason for this is considered as follows. Due to the crystal structure of the layered silicate, the plane faces of the platy particle have negative charge since oxygen atoms concentrate in the plane faces, and the side has positive charge since metal ions are present in the side. Therefore, as the ratio of the area of the plane face to the area of the side is larger, the negative charge of the plane face is also larger, and the layered silicate particle as a whole has larger negative charge. Then, the repulsion between the layered silicate particles and the fluorinated solvent due to electrostatic interaction becomes larger, and as a result, the formation of an SEI film derived from a fluorinated solvent is efficiently suppressed. In the case of platy particles having a ratio of the area of the plane face to the area of the side of 12.5 or more, the plane face probably has, for example, 10 to 90 mmol/100 g of negative charge, depending on the composition and the size of the crystal structure of the layered silicate. If platy particles having a ratio SB/SA of 20 or more are used, the formation of an SEI film derived from a fluorinated solvent is excessively prevented, and then, the excessive decomposition of non-aqueous electrolyte may not be suppressed.

The area of the side and the area of the plane face is calculated as follows using an FE-SEM with a field emission (FE) electron source (for example, a field emission scanning electron microscope (FE-SEM) manufactured by Hitachi High-Technologies Corporation).

### (Calculation of Area of Plane Face)

Among platy particles present in the field of view of an FE-SEM, twenty platy particles with the plane face thereof full-faced to the field of view are selected. The circumference of the plane face of each of the twenty platy particles is measured, and the average thereof is determined. The area of the plane face, SB, is calculated from the average of the circumference and the circular constant, regarding the plane face as a circle.

### (Calculation of Area of Side)

Among platy particles present in the field of view of an FE-SEM, twenty platy particles with the side thereof full-faced to the field of view are selected. The thickness (width of the side) of each of the twenty platy particles is measured, and the average thereof is determined. The area of the side, SA, is calculated from the average of the thickness of the platy particles and the average of the circumference calculated above.

For example, the content of the layered silicate particles is preferably 0.05 mass % or more and 5 mass % or less, more preferably 0.1 mass % or more and 1 mass % or less, based on the total amount of the negative electrode active material. If the content of the layered silicate is less than 0.05 mass %, the amount produced of the SEI film derived from a fluorinated solvent may be larger to thereby increase the resistance of the negative electrode in an environment at a low temperature, compared to the case where the content of the layered silicate particles is within the range described above. If the content of the layered silicate is more than 5 mass % based on the total amount of the negative electrode active material, the layered silicate particles may aggregate, and the negative electrode mixture slurry may thus gel to thereby fail to apply the slurry to the negative electrode collector, compared to the case where the content of the layered silicate particles is within the range described above.

The average diameter of the layered silicate particles is not particularly limited, and for example, it is preferably 10 nm or more and 40 nm or less, more preferably 20 nm or more and 30 nm or less. If the average diameter of the layered silicate particles is less than 10 nm, the amount produced of the SEI film derived from a fluorinated solvent may be larger to thereby increase the resistance of the negative electrode in an environment at a low temperature, compared to the case where the average diameter of the layered silicate particles is within the range described above. If the average diameter of the layered silicate particles is more than 40 nm, a favorable SEI film may not be formed to thereby decrease the cyclic characteristics, compared to the case where the average diameter of the layered silicate particles is within the range described above. The average diameter of the layered silicate particles means a volume average diameter determined according to the laser diffraction method, the volume average diameter being a median diameter at a cumulative volume of 50% in the particle size distribution. The average diameter of the layered silicate particles can be determined with, for example, a laser diffraction/scattering particle size analyzer (manufactured by HORIBA, Ltd.).

As the binder, PTFE or the like can be used as in the case of the positive electrode, and a styrene/butadiene copolymer (SBR) or the modified product thereof may also be used, for example.

The negative electrode active material layer preferably includes a polymeric thickener, and examples thereof include carboxymethylcellulose (CMC) and polyethylene oxide (PEO). These may be used singly or in combinations of two or more. The molecules of the polymeric thickener are polymerized through hydrogen bonds with the layered silicate. Thus, the strength of the negative electrode active material layer can be improved by co-existence of the thickener and the layered silicate.

### [Separator]

An ion-permeable and insulating porous sheet is used as the separator, for example. Specific examples of the porous sheet include a microporous thin film, woven fabric, and nonwoven fabric. Suitable examples of the material for the separator include olefin resins such as polyethylene and polypropylene, and cellulose. The separator may be a laminate including a cellulose fiber layer and a layer of fibers of a thermoplastic resin such as an olefin resin. The separator may be a multi-layered separator including a polyethylene layer and a polypropylene layer, and a separator a surface of which is coated with a material such as an aramid resin or ceramic may also be used as the separator.

### EXAMPLES

The present disclosure will be further described by way of Example below, but is not limited to the following Example.

### Example

### [Production of Positive Electrode]

A lithium composite oxide represented by the general formula: LiNiCoAlO₂ (Ni: 80 mol %, Co: 15 mol %; Al: 5 mol %) was used as a positive electrode active material. 95 mass % of the positive electrode active material, 3 mass % of acetylene black as an electrical conductor, and 2 mass % of polyvinylidene fluoride as a binder were mixed, and N-methyl-2-pyrrolidone (NMP) was added thereto to prepare a positive electrode mixture slurry. Then, the positive electrode mixture slurry was applied to both sides of a positive electrode collector made of aluminum having a thickness of 15 μm according to the doctor blade method, and the resulting coating was rolled to form a positive electrode active material layer having a thickness of 70 μm on each side of the positive electrode collector. The resulting product was used as a positive electrode.

### [Production of Negative Electrode]

98 mass % of graphite as the negative electrode active material, 1 mass % of a styrene/butadiene copolymer (SBR) as a binder, 0.8 mass % of carboxymethylcellulose (CMC) as a polymeric thickener, and 0.2 mass % of Na^{+0.7}[(Si₈Mg_{5.5}Li_{0.3})O₂₀(OH)₄]^{-0.7} (Laponite-RD, manufactured by BYK Japan KK) as a layered silicate were mixed, and water was added thereto to prepare a negative electrode mixture slurry. Then, the negative electrode mixture slurry was applied to both sides of a negative electrode collector made of copper having a thickness of 10 μm according to the doctor blade method, and the resulting coating was rolled to form a negative electrode active material layer having a thickness of 100 μm on each side of the negative electrode collector. The resulting product was used as a negative electrode.

### [Preparation of Electrolyte]

In a mixed solvent consisting of fluoroethylene carbonate (FEC), ethyl methyl carbonate (EMC), and dimethyl carbonate (DMC) mixed in a volume ratio of 20:5:75 at room temperature, LiPF₆ was dissolved at a concentration of 1.3 mol/L to prepare an electrolyte.

### [Production of Battery]

The positive electrode and the negative electrode were each cut into a given size, followed by attaching an electrode tab to each electrode, and they were wound together with the separator therebetween to thereby produce an electrode assembly of wound type. Then, the electrode assembly with dielectric plates disposed on its top and bottom was housed in an exterior can made of steel plated with Ni and having a diameter of 18 mm and a height of 65 mm. The tab for the negative electrode was welded to the inner bottom of the battery exterior can, and the tab for the positive electrode was welded to the bottom plate of a sealing member. The electrolyte above described was poured in the exterior can through the opening thereof, and the exterior can was hermetically closed with the sealing member to produce a battery.

### COMPARATIVE EXAMPLE

A battery was produced in the same manner as in Example, except that 98 mass % of graphite as a negative electrode active material, 1 mass % of a styrene/butadiene copolymer (SBR) as a binder, and 1 mass % carboxymethylcellulose (CMC) as a polymeric thickener were mixed and that a layered silicate was not added, in the production of the negative electrode.

### [Measurement of Resistance of Negative Electrode in Environment at Low Temperature]

A charge to an SOC of 10% was carried out on each of batteries of Example and Comparative Example under conditions of a temperature of 10° C. and a constant current corresponding to a current of 0.2 C. A charge to an SOC of 10% means a charge to 10% relative to 100% of the full charge of the cell for the test. After the charge to an SOC of 10%, an impedance measurement (frequency: 1 MHz to 0.05 Hz, amplitude: 10 mV) was carried out, and a Cole-Cole plot prepared therefrom was analyzed to thereby determine the resistance of the negative electrode. For the resistance of the negative electrode, the rate of the resistance of the negative electrode of the battery of Example was calculated on the basis of the resistance (100%) of the negative electrode of the battery of Comparative Example. The result is shown in Table 1.

### [Charging/Discharging Cycle Test]

A constant-current charge was carried out on each of batteries of Example and Comparative Example under conditions of a temperature of 25° C., a charging current corresponding to 0.5 C, and a charge cutoff voltage of 4.15 V, and then a constant-voltage charge was carried out thereon to a current corresponding to 0.02 C. After a rest of 10 minutes, a constant-current discharge was carried out thereon to a voltage of 3.0 V under condition of a discharging current corresponding to 0.5 C, followed by a rest of 10 minutes. Such a charging/discharging cycle was carried out 100 times, and the capacity retention rate was calculated. The results are shown in Table 1.

Capacity Retention Rate (%)=Discharge Capacity at 100th Cycles/Discharge Capacity at First Cycle

TABLE 1

| | | | Rate of | |
|---|---|---|---|---|
| | | Presence | Resistance | Capacity |
| | Presence | of Layered | of Negative | Retention |
| | of FEC | Silicate | Electrode | Rate |
| Comparative | yes | no | 100% | 98.8% |
| Example | | | | |
| Example | yes | yes | 75% | 98.8% |

The battery of Example was not different in the capacity retention rate after 100 cycles of charging/discharging from the battery of Comparative Example, and the battery of Example thus had a comparable performance to that of Comparative Example. However, the battery of Example had a lower resistance of the negative electrode than the battery of Comparative Example in an environment at a low temperature. It can be said from this result that in a non-aqueous electrolyte secondary battery in which a non-aqueous electrolyte including a fluorinated solvent is used, the increase in the resistance of the negative electrode in an environment at a low temperature can be suppressed by using a negative electrode active material layer that includes: a negative electrode active material including a carbon active material; and layered silicate particles.

Reference Examples will be given below, in which an effect provided by adding layered silicate particles was examined in a non-aqueous electrolyte secondary battery in which a non-aqueous electrolyte free from fluorinated solvents was used.

### Reference Example 1

A battery was produced in the same manner as in Example, except that an electrolyte was used which was prepared by dissolving LiPF₆ at a concentration of 1.3 mol/L in a mixed solvent consisting of ethylene carbonate (EC), ethyl methyl carbonate (EMC), and dimethyl carbonate (DMC) mixed in a volume ratio of 20:5:75 at room temperature and that a layered silicate was not added in the preparation of the negative electrode.

### Reference Example 2

A battery was produced in the same manner as in Example, except that an electrolyte was used which was prepared by dissolving LiPF₆ at a concentration of 1.3 mol/L in a mixed solvent consisting of ethylene carbonate (EC), ethyl methyl carbonate (EMC), and dimethyl carbonate (DMC) mixed in a volume ratio of 20:5:75 at room temperature.

The resistance of the negative electrode of each batteries of Reference Examples 1 and 2 was determined in an environment at a low temperature under the same conditions as described above. The rate of the resistance of the negative electrode of the battery of Reference Example 2 was calculated on the basis of the resistance (100%) of the negative electrode of the battery of Reference Example 1. The result is shown in Table 2.

The charging/discharging test of 100 cycles was carried out on the batteries of Reference Examples 1 and 2 under the same conditions as described above, and the capacity retention rate was calculated in the same manner as in Example. The result is shown in Table 2.

TABLE 2

| | | | Rate of | |
|---|---|---|---|---|
| | | Presence | Resistance | Capacity |
| | Presence | of Layered | of Negative | Retention |
| | of FEC | Silicate | Electrode | Rate |
| Reference | no | No | 100% | 97.7% |
| Example 1 | | | | |
| Reference | no | yes | 94% | 97.9% |
| Example 2 | | | | |

There was almost no difference between the batteries of Reference Examples 1 and 2 in the capacity retention rate after 100 cycles of charging/discharging. Also, the battery of Reference Example 2 had a lower resistance of the negative electrode than the battery of Reference Example 1 in an environment at a low temperature. It can be said from this result that the increase in the resistance of the negative electrode in an environment at a low temperature can be suppressed by using a negative electrode active material layer that includes: a negative electrode active material including a carbon active material; and layered silicate particles. However, the batteries of Reference Examples 1 and 2, in which a non-aqueous electrolyte free from fluorinated solvents is used, provided a decreased capacity retention rate after 100 cycles of charging/discharging compared to the batteries of Example and Comparative Example, in which a non-aqueous electrolyte including a fluorinated solvent is used. Thus, it is necessary to incorporate a fluorinated solvent into a non-aqueous electrolyte.

### REFERENCE SIGNS LIST

10 Platy Particle

12 Plane Face

14 Side

1. A non-aqueous electrolyte secondary battery comprising:
a negative electrode having a negative electrode active material layer;
a positive electrode; and
a non-aqueous electrolyte including a non-aqueous solvent,
wherein the negative electrode active material layer includes: a negative electrode active material including a carbon active material; and layered silicate particles, and
the non-aqueous solvent includes a fluorinated solvent.

2. The non-aqueous electrolyte secondary battery according to claim 1, wherein the layered silicate particles are platy particles defined by a pair of plane faces that faces each other and a side extending along the circumferences of the plane faces, and a ratio SB/SA of an area of the plane face of the platy particle, SB, to an area of the side of the platy particle, SA, is 12.5 or more.

3. The non-aqueous electrolyte secondary battery according to claim 1, wherein the content of the fluorinated solvent is 5 vol % or more and 30 vol % or less based on the total volume of the non-aqueous solvent.

4. The non-aqueous electrolyte secondary battery according to claim 1, wherein the fluorinated solvent includes fluoroethylene carbonate.

5. The non-aqueous electrolyte secondary battery according to claim 1, wherein the content of the layered silicate is 0.05 mass % or more and 5 mass % or less based on the total amount of the negative electrode active material.

6. The non-aqueous electrolyte secondary battery according to claim 1, wherein the negative electrode active material layer includes a polymeric thickener.
